(19) United States
(12) Patent Application Publication
(10) Pub. No.: US 2009/0281866 A1
(43) Pub. Date: Nov. 12, 2009

(54) WORKFLOW CONTROL APPARATUS, WORKFLOW CONTROL METHOD, AND WORKFLOW CONTROL PROGRAM EMBODIED ON COMPUTER READABLE MEDIUM

(75) Inventor: Tsuyoshi Morimoto, Itami-shi (JP)

Correspondence Address: BUCHANAN, INGERSOLL & ROONEY PC, POST OFFICE BOX 1404, ALEXANDRIA, VA, 22313-1404, US

(73) Assignee: KONICA MINOLTA BUSINESS TECHNOLOGIES, INC., Chiyoda-ku (JP)

(21) Appl. No.: 12/435,093

(22) Filed: May 4, 2009

(30) Foreign Application Priority Data
May 9, 2008 (JP) 2008-123205

(51) Int. Cl. G06Q 10/00; G05B 19/02; G06F 3/048

(52) U.S. Cl. 705/9; 700/17; 715/709

(57) ABSTRACT

In order to facilitate generation of a workflow and setting of a parameter by an operator, a server includes a job generating portion which generates a job including two or more processes selected from among a plurality of processes, a workflow generating portion which generates a workflow by assigning each of the two or more processes to at least one operator capable of processing the process with reference to skill data indicating for each of the processes at least one operator capable of processing the process, a setting screen output portion which outputs a setting screen for allowing an operator to input a parameter for each of the two or more processes included in the workflow, a parameter accepting portion which accepts the parameter input by the operator in accordance with the setting screen, and a setting portion which sets the accepted parameter.

This application is based on Japanese Patent Application No. 2008-123205 filed with Japan Patent Office on May 9, 2008, the entire content of which is hereby incorporated by reference.

### BACKGROUND OF THE INVENTION

1. Field of the Invention

The present invention relates to a workflow control apparatus, a workflow control method, and a workflow control program embodied on a computer readable medium. More specifically, the present invention relates to a workflow control apparatus, a workflow control method, and a workflow control program embodied on a computer readable medium which enable a plurality of operators to carry out a workflow including a plurality of process steps.

2. Description of the Related Art

Printing and bookbinding, which may be performed based on the print data obtained from a customer, are made up of a plurality of processes including editing of the print data, printing, and bookbinding, and control parameters are set to run the processes. Some of the control parameters require certain skill to set them, while others do not. As a technique of facilitating the setting of the control parameters, Japanese Patent Application Laid-Open No. 2003-276150 describes a workflow control apparatus wherein an assist setting screen displays a workflow for making a printing plate for a specific printed matter as well as a menu and a field for allowing the user to input a keyword related to the workflow. In the apparatus, when the user sets a keyword, control parameters suited for a plurality of process steps of the workflow are determined in accordance with the keyword.

The conventional workflow control apparatus is applicable to the case where operators are assigned to the work of setting the parameters for the respective processes defined in the workflow. Although there is no problem when all the operators can carry out the respective processes defined in the workflow, if there is an operator who cannot execute the processes, or if the operators vary in their skills, it would be necessary to assign each of the processes to the operator who can carry out the corresponding process.

For a workflow in which processes to be carried out by the workflow are predetermined, it will be possible to pre-assign the processes defined in the workflow to the operators. In the case of a workflow in which processes to be carried out thereby are not predetermined, however, the operators will have to be assigned later. In order to assign the plurality of processes defined in the workflow to operators, the operators' skills will have to be known in advance.

### SUMMARY OF THE INVENTION

The present invention has been accomplished in view of the foregoing problems, and an object of the present invention is to provide a workflow control apparatus which facilitates generation of a workflow and also facilitates setting of a parameter by an operator.

Another object of the present invention is to provide a workflow control method which facilitates both generation of a workflow and setting of a parameter by an operator.

Yet another object of the present invention is to provide a workflow control program which facilitates both generation of a workflow and setting of a parameter by an operator.

In order to achieve the above-described objects, according to an aspect of the present invention, a workflow control apparatus is provided which includes: a skill data storing portion to store skill data indicating, for each of a plurality of processes, at least one operator capable of processing the process; a job generating portion to generate a job including two or more processes selected from among the plurality of processes; a workflow generating portion to generate a workflow, with reference to the skill data, by assigning each of the two or more processes included in the generated job to at least one operator capable of processing the process; a setting screen output portion to output a setting screen for allowing an operator to input a parameter for each of the two or more processes included in the generated workflow; an accepting portion to accept the parameter input by the operator according to the setting screen displayed; and a setting portion to set the accepted parameter.

According to another aspect of the present invention, a workflow control method is provided which includes the steps of: storing skill data indicating, for each of a plurality of processes, at least one operator capable of processing the process: accepting an input of a job including two or more processes selected from among the plurality of processes; assigning each of the two or more processes included in the accepted job to at least one operator capable of processing the process with reference to the skill data; outputting a setting screen for allowing an operator to input a parameter for each of the two or more processes included in the accepted job; accepting the parameter input by the operator in accordance with the setting screen displayed; and setting the accepted parameter.

According to yet another aspect of the present invention, a workflow control program embodied on a computer readable medium is provided, which program causes a computer to carry out the steps of: storing skill data indicating, for each of a plurality of processes, at least one operator capable of processing the process; accepting an input of a job including two or more processes selected from among the plurality of processes; assigning each of the two or more processes included in the accepted job to at least one operator capable of processing the process with reference to the skill data; outputting a setting screen for allowing an operator to input a parameter for each of the two or more processes included in the accepted job; accepting the parameter input by the operator in accordance with the setting screen displayed; and setting the accepted parameter.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 schematically shows a workflow system according to an embodiment of the present invention.

FIG. 2 is a block diagram showing an example of the hardware configuration of a server.

FIG. 3 is a functional block diagram schematically showing the functions of a CPU included in the server.

FIG. 4 shows an example of a skill check form.

FIG. 5 shows an example of skill data.

FIG. 6 shows an example of the format of a work record.

FIGS. 7 to 10 show examples of a setting screen.

FIG. 11 is a flowchart illustrating an example of the flow of skill data generating processing.

FIG. 12 is a flowchart illustrating an example of the flow of workflow generating processing.

FIG. 13 is a flowchart illustrating an example of the flow of parameter setting processing.

FIG. 14 is a flowchart illustrating an example of the flow of setting screen generating processing.

### DESCRIPTION OF THE PREFERRED EMBODIMENTS

Embodiments of the present invention will now be described with reference to the drawings. In the following description, like reference characters denote like parts, which have like names and functions, and therefore, detailed description thereof will not be repeated.

FIG. 1 schematically shows a workflow system according to an embodiment of the present invention. Referring to FIG. 1, a workflow system 1 includes printers 100 and 101, a server 200 serving as a workflow control apparatus, and personal computers (hereinafter, referred to as “PCs”) 301 and 303, which are each connected to a network 2.

Network 2 is a local area network (LAN) connected to the Internet 3 via a gateway. Network 2 may be connected in a wired or wireless manner. Further, network 2 is not necessarily the LAN; which may be a network using public switched telephone networks (PSTN), a wide area network (WAN), the Internet, or the like. Internet 3 is connected with a PC 305.

Server 200, a typical computer, has a workflow control program installed therein. Server 200 receives print data from PC 305 connected to Internet 3. Based on the received print data, server 200 generates a workflow for managing the works performed by operators. The processing carried out by server 200 will be described later in detail.

Printers 100 and 101 each have an image forming function for forming an image on a recording medium such as a sheet of paper based on the print data transmitted from server 200, and a function of binding the sheets of paper with the images formed thereon. Printers 100 and 101 are controlled by server 200. Here, it is assumed that printer 100 has the image forming function of forming an image with a black toner, while printer 101 has the image forming function of forming an image in full color with toners of four colors of cyan, magenta, yellow, and black. Printers 100 and 101 are identical in function except for the images' constituent colors, and thus, printer 100 will be described representatively.

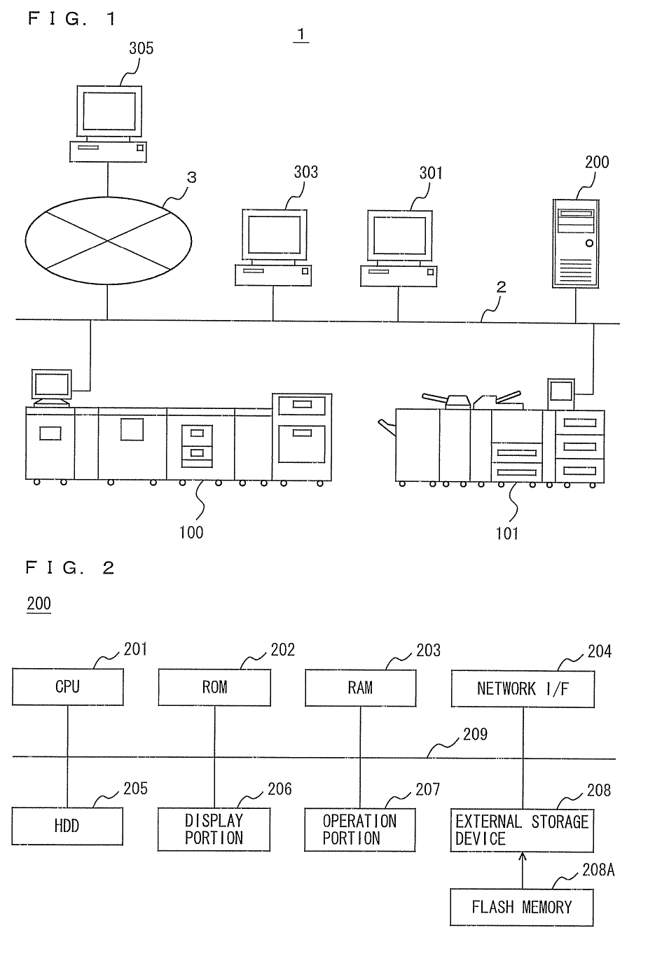

FIG. 2 is a block diagram showing an example of the hardware configuration of the server. Referring to FIG. 2, server 200 includes: a central processing unit (CPU) 201 which is responsible for overall control of server 200; a read only memory (ROM) 202; a random access memory (RAM) 203; a network interface (I/F) 204 for connecting server 200 to a network; a hard disk drive (HDD) 205 serving as a mass storage; a display portion 206; an operation portion 207 for accepting an input of a user's operation; and an external storage device 208.

ROM 202 stores a program executed by CPU 201, or data necessary for the program to be executed. RAM 203 is used as a work area when CPU 201 executes the program.

Display portion 206 corresponds to a display device such as an LCD (liquid crystal display) or an organic ELD (electroluminescence display), which displays an instruction menu to the user and the like. Operation portion 207 includes a plurality of keys and accepts inputs of data such as instructions, characters, and numeral characters, in accordance with the user's key operations. Operation portion 207 may include a pointing device such as a mouse.

Network I/F 204 is an interface for connecting server 200 to network 2. CPU 201 transmits and receives data to and from PCs 300, 301 and printers 100, 101 via network I/F 204. Network I/F 204 is also communicable with PC 305 connected to Internet 3 via network 2.

External storage device 208 has a removable recording medium mounted thereon, which may be a flash memory 208A. CPU 201 can access flash memory 208A mounted on external storage device 208. CPU 201 loads the program recorded on flash memory 208A that is mounted on external storage device 208, to RAM 203 for execution. The program which is executed by CPU 201 is not restricted to the one recorded on flash memory 208A. The program stored in HDD 205 may be loaded to RAM 203 for execution. In this case, another computer connected to network 2 may rewrite the program stored in HDD 205 of server 200, or additionally write a new program thereto. Further, server 200 may download a program from another PC 301 or 303 connected to network 2 and store the program in HDD 205. As used herein, the program includes, not only the one directly executable by CPU 201, but also a source program, a compressed program, an encrypted program, and the like.

It is noted that the recording medium for storing the program is not restricted to flash memory 208A. It may be a magnetic storage device such as a flexible disk, a cassette tape, or an HDD, an optical disc (MO (Magnetic Optical Disc), MD (Mini Disc), DVD (Digital Versatile Disc)), an IC card (including a memory card), an optical card, or a semiconductor memory such as a mask ROM, an EPROM (Erasable Programmable ROM), an EEPROM (Electronically EPROM), or the like.

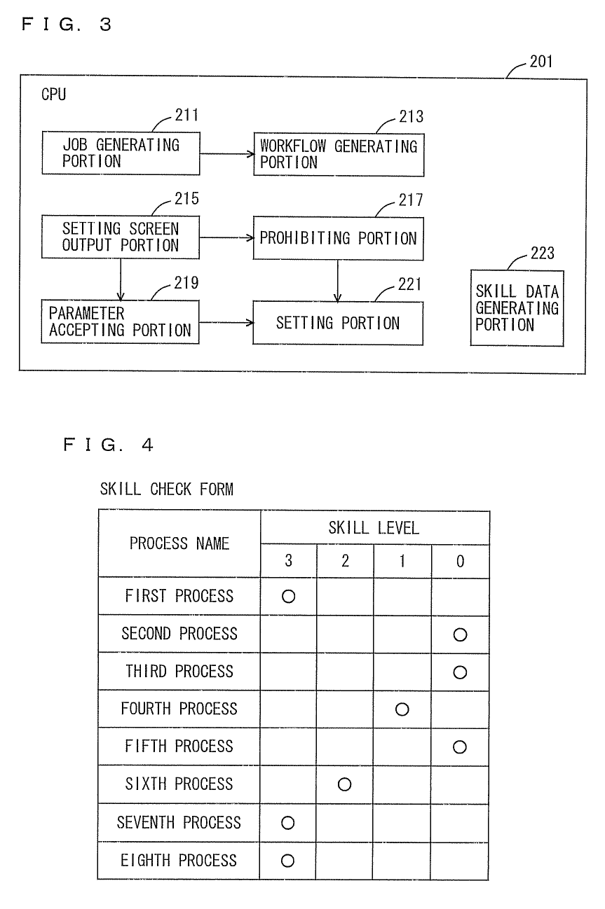

FIG. 3 is a functional block diagram schematically showing the functions of the CPU included in the server. Referring to FIG. 3, CPU 201 includes: a skill data generating portion 223 which generates skill data defining skills of respective operators; a job generating portion 211 which generates a job ticket; a workflow generating portion 213 which generates a workflow in which a plurality of processes defined in the job ticket are assigned to respective operators; a setting screen output portion 215 which outputs a setting screen for each of the processes; a parameter accepting portion 219 which accepts a parameter input in accordance with the setting screen; a prohibiting portion 217 which prohibits acceptance of a parameter; and a setting portion 221 which sets a parameter.

When one of PCs 301, 303 connected to network 2 accesses network I/F 204, skill data generating portion 223 transmits a skill check form. The skill check form, which is prestored in HDD 205, is a screen used for setting an operator's skill for each of a plurality of processes. The processes include all the processes carried out in workflow system 1.

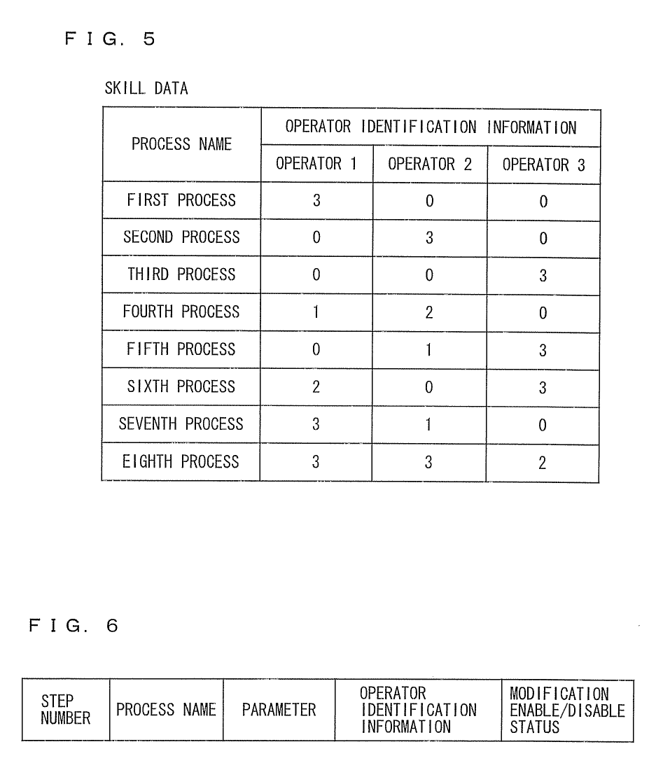

FIG. 4 shows an example of the skill check form. Referring to FIG. 4, the skill check form includes a field for filling in a mark “O” to indicate that the operator “can perform the process” for each of a plurality of process names identifying the respective processes. Specifically, a plurality of fields for filling in the mark indicating that the operator “can perform the process” are provided for different skills. FIG. 4 shows the example of the skill check form which is filled in by the operator with operator identification information “operator 1” who has the level 3 skill with respect to the first, seventh and eighth processes, level 2 skill for the sixth process, and level 1 skill for the fourth process. The form indicates that the operator has the level 0 skill for the second, third, and fifth processes; i.e., the operator cannot carry out those processes. The skill levels are defined based on the likelihood that the operator is capable of executing the process, as well as the process speed. The greater numerical value indicates that the operator can carry out the process more accurately and more speedily.

In the case where the user with the operator identification information “operator 1” is operating PC 301, when the user inputs the marks indicating his/her skills for the respective processes in accordance with the skill check form, PC 301 transmits the skill levels for the processes. When network I/F 204 receives the skill levels for the processes from PC 301, skill data generating portion 223 accepts them from network I/F 204.

Skill data generating portion 223 generates skill data in which the accepted skill levels for the respective processes are associated with the operator identification information “operator 1”, and stores the data in HDD 205. In this manner, the skill data for a respective operator is stored in HDD 205.

FIG. 5 shows an example of the skill data. Referring to FIG. 5, the skill data defines, for each of the operators, the skill levels relative to the respective processes. When all the operators input their skills in accordance with the skill check form, the skill data of all the operators are stored in HDD 205 by skill data generating portion 223, whereby the skill data is completed.

Server 200 functioning as a Web server can readily implement skill data generating portion 223. In such a case, the skill check form is a Web page described in a markup language such as HTML (Hypertext Markup Language) or XML (Extensible Markup Language). The Web page includes a command to accept the skill levels for respective processes and transmit them to server 200.

Returning to FIG. 3, when PC 305 connected to Internet 3 accesses network I/F 204, job generating portion 211 transmits a job setting screen. The job setting screen, which is prestored in HDD 205, is a screen used for setting a job. The job setting screen includes a field for designating the data on which the job is executed, and a field for designating at least one of a plurality of processes. More specifically, the job setting screen includes a list of process names of the plurality of processes that can be provided by workflow system 1 and descriptions for the respective processes, and has check boxes for selecting any of the listed processes.

When the user of PC 305 designates the data and at least one of the process names in accordance with the job setting screen, PC 305 transmits the data and the process name(s) designated from among the processes. When network I/F 204 receives the data and the process name(s) from PC 305, job generating portion 211 accepts them from network I/F 204.

Job generating portion 211 generates a job ticket in which the accepted data is associated with the process names, and outputs it to workflow generating portion 213. The job ticket is the data in which the data to be processed is associated with the process names of the processes to be performed on the data. Here, it is assumed that the first through eighth processes are designated on the job setting screen and, thus, the job ticket includes the process names of the first through eighth processes.

Server 200 functioning as a Web server can readily implement job generating portion 211. In such a case, the job setting screen is a Web page described in HTML, XML or another markup language. The Web page includes a command to accept the data and the process names and transmit them to server 200.

Workflow generating portion 213 refers to the skill data to assign the processes included in the input job ticket to the respective operators, to thereby generate a workflow. Specifically, it assigns each of the first through eighth processes included in the job ticket to the operator who can handle the process. The operator capable of carrying out the process corresponds to the operator having the skill level of 1 or higher in the skill data. The operators having the skill level of 1 or higher for a certain process may all be assigned, or an operator having a higher skill level may preferentially be assigned. For example, the operator having the highest skill level for a certain process may be assigned. If there is more than one operator having the highest skill level, all of them or a selected one of them may be assigned. Workflow generating portion 213 stores the generated workflow in HDD 205. As such, every time job generating portion 211 generates a job ticket, workflow generating portion 213 generates and stores one workflow. The workflow includes work records of the same number as that of the received process names. When a plurality of job tickets are generated, a plurality of workflows are generated correspondingly. In such a case, the workflows are stored in HDD 205 with workflow names applied to the respective workflows for identification thereof.

FIG. 6 shows an example of the format of the work record. Referring to FIG. 6, the work record includes: a step number field, a process name field, a parameter field, an operator identification information field, and a modification enable/disable status field. In the process name field, the process name accepted by job generating portion 211 is set. In the step number field, the step number pre-assigned to the process having the process name set in the process name field is set. In the parameter field, the parameter for use in carrying out the process having the process name set in the process name field is set. In the operator identification information field, the operator identification information for identification of the operator who can execute the process having the process name set in the process name field is set. In the modification enable/disable status field, the information as to whether it is possible to modify the parameter set in the parameter field is set. At the time point when the workflow is generated by workflow generating portion 213, the step number, the process name, and the operator identification information are set in the corresponding fields in the work record, while nothing is set in the other fields, which are left blank or set as NULL. While it is assumed that a single field is provided for the operator identification information, the work record may have a plurality of fields of operator identification information in the case where a plurality of operators are assigned for one process. Further, in the case where a plurality of operators are assigned for one process, in order to specify the operator who has set a parameter, the work record includes setting status fields corresponding respectively to the operator identification information fields. In the setting status field, “0” is set as default, and “1” is set for the operator who has set the parameter.

When one of PCs 301, 303 connected to network 2 accesses a workflow via network I/F 204, setting screen output portion 215 generates a setting screen. In the case where a plurality of workflows are stored in HDD 205, the access is accepted when a workflow name is received from one of PCs 301, 303. Setting screen output portion 215 generates a setting screen on which the process names set in the process name fields of the respective work records included in the designated workflow are displayed in a selectable manner, which are in this case the first through eighth processes. Then, setting screen output portion 215 transmits the generated setting screen to the one of PCs 301, 303 that made the access to the workflow. Further, setting screen output portion 215 outputs, to parameter accepting portion 219 and prohibiting portion 217, device identification information of the device to which it transmitted the setting screen. Here, the device identification information is an IP (Internet Protocol) address or a MAC (Media Access Control) address. The setting screen is a screen which lists the process names included in the workflow, and is used for setting parameters for the respective processes.

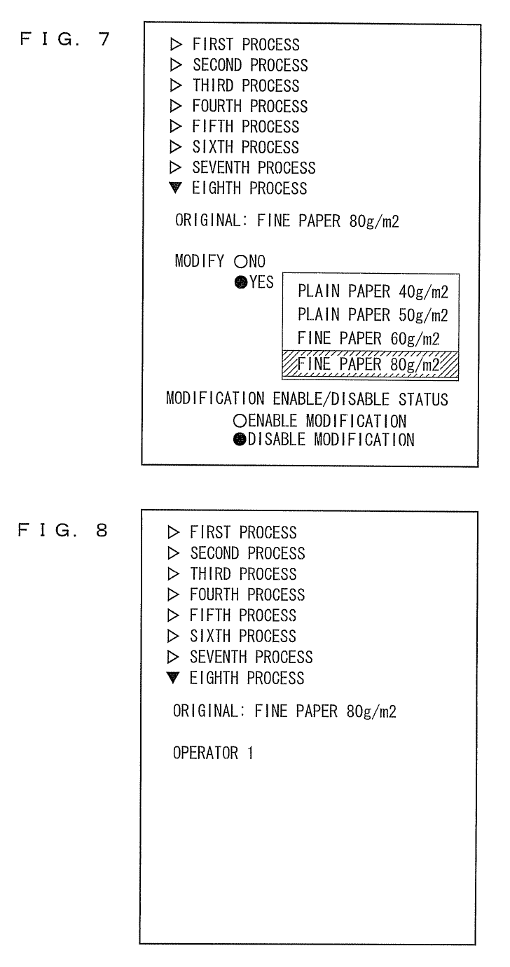

FIG. 7 shows an example of the setting screen. Shown here is the setting screen which is transmitted from server 200 when the operator with the operator identification information “operator 1” is operating PC 301. Referring to FIG. 7, the setting screen selectably displays the first through eighth processes which are set in the process name fields of the respective work records included in the workflow. Specifically, FIG. 7 shows the case where the process name “eighth process” has been selected. The area for accepting a parameter is displayed below the selected process name “eighth process”. When the operator inputs a parameter to PC 301, PC 301 transmits a set of the input parameter and the process name to server 200. Here, it is assumed that “paper type” is set as the parameter for the process name “eighth process”, and a parameter “fine paper 80 g/m²” is input relative to the parameter name “paper type”.

Further, the area for accepting the modification enable/disable status is displayed in the lowest area of the setting screen. Specifically, a check box to “disable modification” and a check box to “enable modification” can be selected exclusively. When the check box to “disable modification” is selected, PC 305 transmits a set of the modification enable/disable status indicating “modification disabled” and the process name to server 200, while when the check box to “enable modification” is selected, it transmits a set of the modification enable/disable status indicating “modification enabled” and the process name to server 200.

Returning to FIG. 3, when network I/F 204 receives the set of the process name and the parameter from PC 301 that is specified by the device identification information input from setting screen output portion 215, parameter accepting portion 219 accepts and outputs the set of the process name and the parameter to setting portion 221.

When network I/F 204 receives the set of the process name and the modification enable/disable status from PC 301 that is specified by the device identification information input from setting screen output portion 215, prohibiting portion 217 accepts and outputs the set of the process name and the modification enable/disable status to setting portion 221.

In receipt of the set of the process name and the parameter from parameter accepting portion 219, setting portion 221 updates the workflow stored in HDD 205. Specifically, it extracts from the workflow stored in HDD 205 the work record including the process name input from parameter accepting portion 219, and replaces the parameter in the parameter field of the extracted work record with the parameter input from parameter accepting portion 219. In this manner, the parameter corresponding to the process name in the workflow is set. Further, in receipt of the set of the process name and the modification enable/disable status from prohibiting portion 217, setting portion 221 updates the workflow stored in HDD 205. Specifically, it extracts from the workflow stored in HDD 205 the work record including the process name input from prohibiting portion 217, and replaces the modification enable/disable status in the extracted work record with the one input from prohibiting portion 217. When the modification enable/disable status indicates that modification is disabled, the modification enable/disable status is overwritten with “modification disabled”, while when the modification enable/disable status indicates that modification is enabled, the modification enable/disable status is overwritten with “modification enabled”.

In the case where parameters are set in the parameter fields in the respective work records included in the workflow, setting screen output portion 215 transmits the setting screen including the parameters. When the user of PC 301, 303 that received the setting screen selects a process name, the parameter set for the process name is displayed. This allows the user to confirm the parameter already set and, thus, to set the parameters for the other processes in conformity with the existing parameter.

In the case where the modification enable/disable status in the work record is set as “modification disabled”, setting screen output portion 215 transmits the setting screen in which modification of the parameter for the corresponding process is disabled. When the user of PC 301, 303 that received the setting screen selects a process name, the parameter set for the process having that process name is displayed. The parameter however cannot be modified. For example in the case where there exists a parameter that is determined in relation to the parameter set for another process, modifying one parameter may create the need to modify the parameter set for the other process. In such a case, modification of both the parameter set for the other process and the parameter determined corresponding thereto is disabled to thereby prevent any operator from modifying either one of the parameters afterwards.

FIG. 8 shows another example of the setting screen. Shown here is the setting screen which is transmitted from server 200 when the operator with the operator identification information “operator 2” is operating PC 301. Referring to FIG. 8, the process name “eighth process” is selected, and the parameter set for the eighth process by the operator “operator 1” is displayed. In the work record having the process name “eighth process” in the workflow, the modification enable/disable status is set as “modification disabled”, and accordingly, the parameter cannot be modified. Further, the operator identification information “operator 1” is displayed beneath the parameter, indicating that the operator 1 has set the parameter. This allows the operator “operator 2” to make an inquiry to or request modification of the parameter to the operator “operator 1”.

Further, setting screen output portion 215 may output the setting screen which includes only the information regarding the processes assigned to the operator who accessed the workflow.

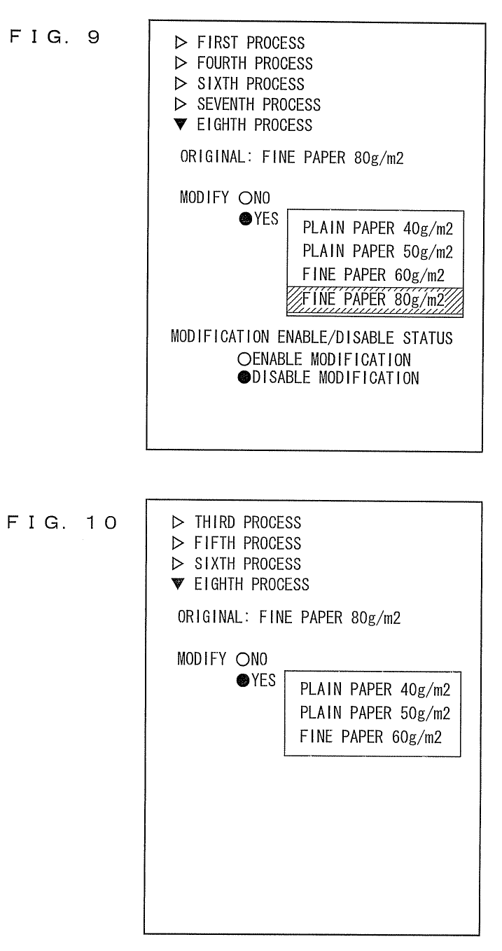

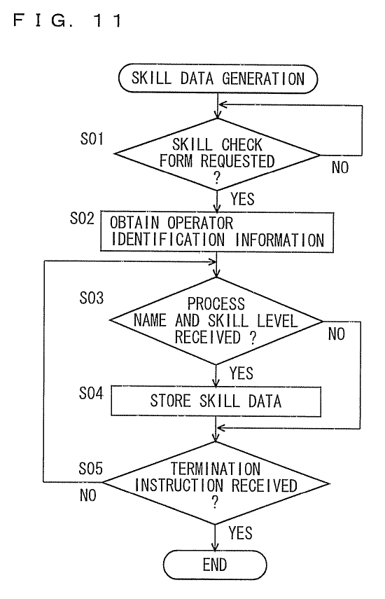

FIG. 9 shows yet another example of the setting screen. Shown here is the setting screen which is transmitted from server 200 when the operator with the operator identification information “operator 1” is operating PC 301. Referring to FIG. 9, the setting screen displays only the first, fourth, sixth, seventh, and eighth processes in a selectable manner. Here, referring to the skill data shown in FIG. 5, the skill level of 1 or higher is set for each of the first, fourth, sixth, seventh, and eighth processes for the operator “operator 1”, meaning that the operator can set the parameters for only the first, fourth, sixth, seventh, and eighth processes.

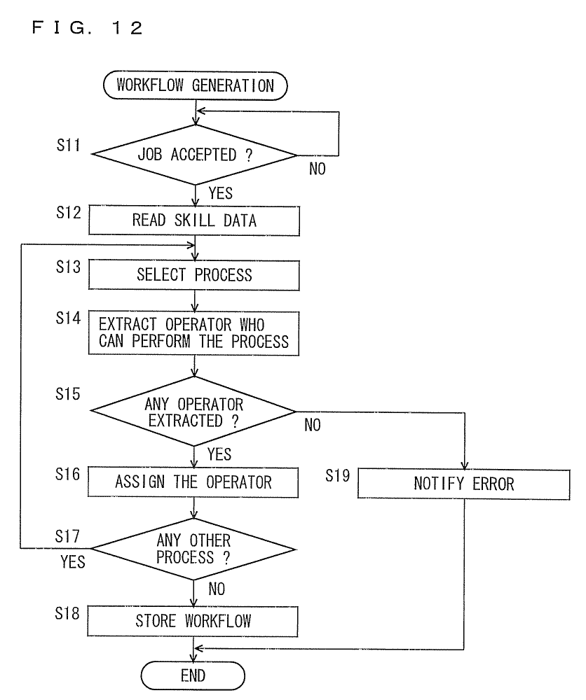

FIG. 10 shows still another example of the setting screen. Shown here is the setting screen which is transmitted from server 200 when the operator with the operator identification information “operator 3” is operating PC 303. Referring to FIG. 10, the setting screen displays only the third, fifth, sixth, and eighth processes in a selectable manner. Referring to the skill data shown in FIG. 5, for the operator identification information “operator 3”, the skill level of 1 or higher is set for each of the third, fifth, sixth, and eighth processes, and accordingly, the operator “operator 3” is capable of setting the parameters only for the third, fifth, sixth, and eighth processes.

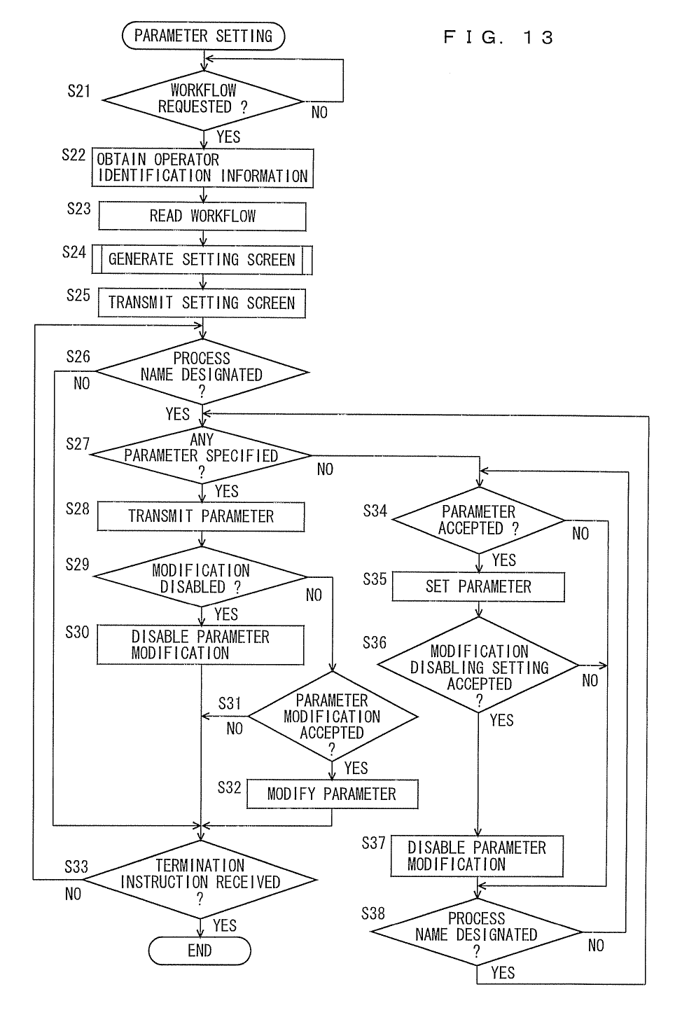

FIG. 11 is a flowchart illustrating an example of the flow of skill data generating processing, which is carried out by CPU 201 in server 200 as CPU 201 executes a workflow control program. Referring to FIG. 11, CPU 201 determines whether a request to transmit a skill check form has been accepted. When network I/F 204 receives the request to transmit the skill check form from one of PCs 301, 303, it accepts the request to transmit the skill check form. Here, it is assumed that the operator with the operator identification information “operator 1” is operating PC 301. CPU 201 is in the standby mode until it accepts the request to transmit the skill check form (NO in step S01), and once it accepts the request (YES in step S01), the process proceeds to step S02.

In step S02, operator identification information is obtained. Specifically, the operator identification information of the operator who instructed transmission of the request for the skill check form, “operator 1” in this case, is obtained. For example, an authentication screen requesting an input of the operator identification information is transmitted to PC 301 to prompt the operator to input the operator identification information.

As described above, the skill check form includes the fields for accepting inputs of the skill levels for the respective names of the first through eighth processes that can be processed in workflow system 1. When the operator with the operator identification information “operator 1” selects any of the fields and inputs an instruction to return the skill check form to PC 301, PC 301 transmits the set of the process name and the skill level to server 200. In step S03, it is determined whether the set of the process name and the skill level has been received. Specifically, it is determined whether network I/F 204 has received the set of the process name and the skill level from PC 301. If so, the process proceeds to step S04; otherwise, the process proceeds to step S05. In step S04, the received set of the process name and the skill level is stored in HDD 205 as skill data, and the process proceeds to step S05.

In step S05, it is determined whether a termination instruction has been received. For example, when the communication session with PC 301 is disconnected, it is determined that the termination instruction has been received. The process is terminated when the termination instruction is received; otherwise, the process returns to step S03.

FIG. 12 is a flowchart illustrating an example of the flow of workflow generating processing, which is carried out by CPU 201 in server 200 as CPU 201 executes the workflow control program.

Referring to FIG. 12, CPU 201 determines whether a job has been accepted (step S11). When there is an access to network I/F 204 from PC 305 connected to Internet 3, a job setting screen is transmitted. When the user of PC 305 designates data and at least one of a plurality of process names in accordance with the job setting screen, PC 305 transmits the data and the designated process name. Network I/F 204 determines whether the data and the process name have been received from PC 305. When the data and the process name are received from PC 305, the job is accepted, and the process proceeds to step S12; otherwise, CPU 201 enters a standby mode. That is, in the workflow generating processing, step S12 and the following steps are carried out only when the job is accepted.

In step S12, the skill data stored in HDD 205 is read, and the process proceeds to step S13. In step S13, one of the process names included in the job accepted in step S11 is selected to be processed.

In the following step S14, the skill data read in step S12 is referred to, whereby the operator identification information of all the operators who can execute the process corresponding to the selected process name is extracted. Alternatively, it may be configured to extract the operator identification information of the operator who has the highest skill level, or in the case where more than one operator is extracted, the operator identification information may be extracted for a predetermined number of operators in order from the one having the highest skill level.

In step S15, it is determined whether the operator identification information for at least one operator has been extracted. If so, the process proceeds to step S16; otherwise, the process proceeds to step S19. In step S19, an error notification is issued, and the process is terminated. The error notification may be an error message displayed on display portion 206, or an e-mail including the error message transmitted to an administrator.

In step S16, the process having the process name selected as the target in step S13 is assigned to the operator extracted in step S14. In the following step S17, it is determined if there are any unselected processes. If so, the process returns to step S13; otherwise, the process proceeds to step S18.

In step S18, the workflow having a plurality of process names accepted in step S11 assigned respectively to the operator identification information in step S16 is stored in HDD 205, and the process is terminated.

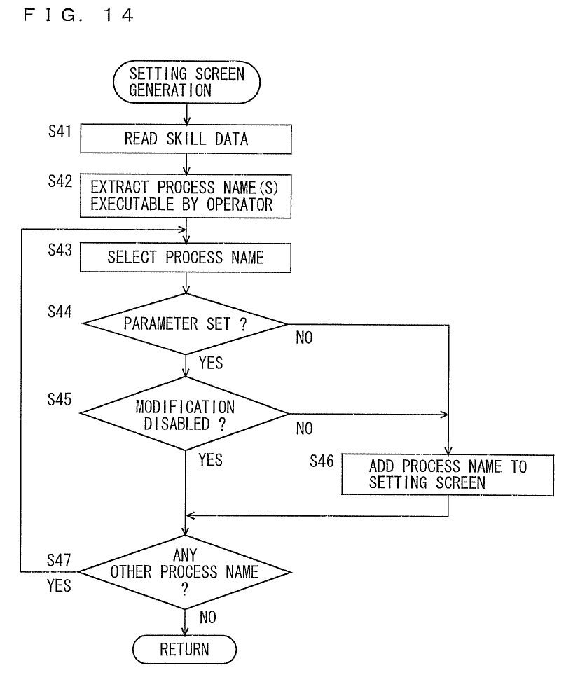

FIG. 13 is a flowchart illustrating an example of the flow of parameter setting processing, which is carried out by CPU 201 in server 200 as CPU 201 executes the workflow control program.

Referring to FIG. 13, CPU 201 determines whether a request to transmit a workflow has been accepted (step S21). When network I/F 204 receives the request to transmit the workflow from one of PCs 301, 303 connected to network 2, the workflow transmission request is accepted. Here, it is assumed that the operator with the operator identification information “operator 1” is operating PC 301. CPU 201 is in the standby mode until it accepts the workflow transmission request (NO in step S21), and once it accepts the workflow transmission request (YES in step S21), the process proceeds to step S22.

In step S22, the operator identification information is obtained. Specifically, the operator identification information of the operator who instructed transmission of the workflow transmission request, here “operator 1”, is obtained. For example, an authentication screen requesting an input of the operator identification information is transmitted to PC 301 to prompt the operator to input the operator identification information.

In the following step S23, the workflow stored in HDD 205 is read. Setting screen generating processing is then carried out (step S24). The setting screen generating processing is for generating a setting screen which is used for setting a parameter. Here, the setting screen including the process names for the processes defined in the workflow is generated. Specifically, the setting screen includes a plurality of process names that are set in the process name fields in the respective work records included in the workflow. In the following step S25, the generated setting screen is transmitted to PC 301 that issued the workflow transmission request.

In step S26, it is determined whether any of the process names included in the setting screen has been designated. If so, the process proceeds to step S27; otherwise, the process proceeds to step S33. In step S27, it is determined whether a parameter has been set corresponding to the process with the designated process name. Specifically, it is determined whether, in the workflow stored in HDD 205, the work record having the designated process name set in its process name field has a parameter set in its parameter field. If the parameter has been set, the process proceeds to step S28; otherwise, the process proceeds to step S34.

In step S28, the parameter set in the workflow is transmitted to PC 301 for display. It is then determined whether modification of the parameter has been disabled (step S29). Specifically, it is determined whether, in the workflow stored in HDD 205, the work record having the designated process name in its process name field has the modification enable/disable status field set as “modification disabled”. If so, the process proceeds to step S30; otherwise, the process proceeds to step S31. In step S30, modification of the parameter is disabled, and the process proceeds to step S33. As a result, even if an instruction to modify the parameter is transmitted from PC 301, the modification is not accepted.

In step S31, it is determined whether the modification of the parameter has been accepted. When network I/F 204 receives a set of the process name and the parameter from PC 301, modification of the parameter is accepted. The parameter is then modified (step S32), and the process proceeds to step S33. Specifically, in the workflow stored in HDD 205, the parameter in the parameter field of the work record having the process name received from PC 301 set in its process name field is replaced with the parameter received from PC 301.

In step S33, it is determined whether a termination instruction has been received from PC 301. If so, the process is terminated; otherwise, the process proceeds to step S26.

In step S34, it is determined whether a parameter has been accepted. When network I/F 204 receives a set of the process name and the parameter from PC 301, the parameter is accepted. If the parameter is accepted, the process proceeds to step S35; otherwise, the process proceeds to step S38. In step S35, the accepted parameter is set. Specifically, in the workflow stored in HDD 205, the parameter received from PC 301 is written into the parameter field of the work record having the process name received from PC 301 set in its process name field.

It is then determined whether modification disabling setting has been accepted (step S36). When network I/F 204 receives a set of the process name and the modification enable/disable status indicating that modification is disabled from PC 301, the modification disabling setting is accepted. If that setting is accepted, the process proceeds to step S37; otherwise, the process proceeds to step S38. In step S37, modification of the parameter is disabled. Specifically, in the workflow stored in HDD 205, “1” indicating “modification disabled” is written into the modification enable/disable status field of the work record having the process name received from PC 301 set in its process name field.

In step S38, it is determined whether any of the process names included in the setting screen has been designated. If so, the process returns to step S27; otherwise, the process returns to step S34.

FIG. 14 is a flowchart illustrating an example of the flow of the setting screen generating processing, which is carried out by CPU 201 in server 200 as CPU 201 executes the workflow control program. The setting screen generating processing is carried out in step S24 in FIG. 13. It is noted that in the case where the setting screen is generated so as not to include the process name of the process for which modification of the parameter is disabled, as will be described later, steps S29 to S32 in FIG. 13 become unnecessary.

Referring to FIG. 14, CPU 201 reads the skill data stored in HDD 205 (step S41). It then extracts the process name of any process executable by the operator (step S42). The operator here is the one who instructed transmission of the workflow transmission request in step S21 in FIG. 13, who is the operator with the operator identification information “operator 1” in this case. Specifically, any process name for which the skill level of 1 or higher is set for the operator “operator 1” in the skill data is extracted. Then, from the plurality of process names set in the process name fields of the respective work records included in the workflow read in step S23 in FIG. 13, the same process name as the one defined as executable by the operator in the skill data is extracted.

Next, one of the extracted process names is selected to be processed (step S43). It is then determined whether a parameter has been set corresponding to the selected process name (step S44). If so, the process proceeds to step S45; otherwise, the process proceeds to step S46. In step S45, it is determined whether the parameter corresponding to the selected process name has been set as “modification disabled”. If so, the process proceeds to step S47; otherwise, the process proceeds to step S46. This is because when a parameter has already been set and its modification is disabled, a new parameter would not be set.

In step S46, the selected process name is added to the setting screen, and the process proceeds to step S47. In step S47, it is determined if there are any unselected process names. If so, the process returns to step S43; otherwise, the process returns to the parameter setting processing. In this manner, the setting screen is generated to include, among the processes defined in the workflow, i.e. among the plurality of process names set in the process name fields of the respective work records included in the workflow, only the process names of the processes executable by the operator who requested transmission of the workflow and those for which a parameter has not been set or the parameter has already been set but modification thereof is enabled.

It is noted that the setting screen may be generated to include, among the processes defined in the workflow, all the process names of the processes executable by the operator who requested transmission of the workflow. In this case, step S43 is followed by step S46 and then step S47, with steps S44 and S45 being skipped. Still alternatively, the setting screen may be generated to include all the process names set in the process name fields of the respective work records included in the workflow.

As described above, server 200 according to the present embodiment serves as the workflow control apparatus. When two or more processes selected from among a plurality of processes are accepted, each process is assigned to at least one operator who can execute the process, whereby the workflow is generated automatically. Further, a setting screen is output to allow an input of a parameter for each of the two or more processes included in the workflow, and once the parameter input by the operator is accepted, the parameter is set. Setting the parameters in accordance with the workflow in this manner enables management of the progress of the work for each workflow.

In the case where the parameter which is to be input in the setting screen generated for the operator with the operator identification information “operator 3” has already been set by the operator with the operator identification information “operator 1” in the setting screen generated for the operator 1, for example, the parameter already set by the operator “operator 1” is displayed in the setting screen generated for the operator “operator 3”. This allows the operator 3 to refer to the parameter set by the other operator.

Further, in the case where the operator with the operator identification information “operator 1”, for example, designates the modification disabling field in the setting screen generated for that operator to prohibit acceptance of modification of the parameter, a new parameter is prevented from being accepted for the parameter for which modification is disabled. This prevents the parameter from being modified later by the operator with the operator identification information “operator 3”, for example.

Furthermore, at least two processes included in the workflow are each assigned preferentially to the operator having the higher skill level. This enables generation of the workflow for which parameters can be set efficiently.

While server 200 has been described as an example of the workflow control apparatus in the above embodiment, the present invention may of course be understood as a workflow control method which executes the processing illustrated in FIGS. 11 to 14, or a workflow control program for causing a computer to carry out the workflow control method.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A workflow control apparatus comprising:
a skill data storing portion to store skill data indicating, for each of a plurality of processes, at least one operator capable of processing the process;
a job generating portion to generate a job including two or more processes selected from among said plurality of processes;
a workflow generating portion to generate a workflow, with reference to said skill data, by assigning each of said two or more processes included in said generated job to at least one operator capable of processing the process;
a setting screen output portion to output a setting screen for allowing an operator to input a parameter for each of said two or more processes included in said generated workflow;
an accepting portion to accept the parameter input by the operator according to said setting screen displayed; and
a setting portion to set said accepted parameter.

2. The workflow control apparatus according to claim 1, wherein in the case where a parameter which is to be input in a first setting screen corresponding to a first process among said two or more processes has been input in a second setting screen corresponding to a second process among said two or more processes and has already been set by said setting portion, said setting screen output portion outputs said first setting screen with said already set parameter displayed thereon.

3. The workflow control apparatus according to claim 2, wherein said setting screen output portion outputs the setting screen including a modification disabling field for allowing the operator to disable modification of the parameter, the workflow control apparatus further comprising
a prohibiting portion, when said modification disabling field is designated, to prohibit acceptance of a new parameter corresponding to the modification disabling field by said accepting portion.

4. The workflow control apparatus according to claim 1, wherein
said skill data includes, for each of the operators, a skill level for the process that the operator is capable of processing, and
said workflow generating portion assigns each of said two or more processes included in said generated job preferentially to the operator having a higher skill level.

5. A workflow control method comprising the steps of:
storing skill data indicating, for each of a plurality of processes, at least one operator capable of processing the process;
accepting an input of a job including two or more processes selected from among said plurality of processes;
assigning each of said two or more processes included in said accepted job to at least one operator capable of processing the process with reference to said skill data;
outputting a setting screen for allowing an operator to input a parameter for each of said two or more processes included in said accepted job;
accepting the parameter input by the operator in accordance with said setting screen displayed; and
setting said accepted parameter.

6. The workflow control method according to claim 5, wherein in the case where a parameter which is to be input in a first setting screen corresponding to a first process among said two or more processes has been input in a second setting screen corresponding to a second process among said two or more processes and has already been set in said setting step, said step of outputting a setting screen includes the step of outputting said first setting screen with said already set parameter displayed thereon.

7. The workflow control method according to claim 6, wherein said step of outputting a setting screen further includes the steps of
outputting the setting screen including a modification disabling field for allowing the operator to disable modification of the parameter, and
in the case where said modification disabling field is designated, prohibiting acceptance of a new parameter corresponding to the modification disabling field in said step of accepting the parameter.

8. The workflow control method according to claim 6, wherein
said skill data includes, for each of the operators, a skill level for the process that the operator is capable of processing, and
said assigning step includes the step of assigning each of said two or more processes included in said accepted job preferentially to the operator having a higher skill level.

9. A workflow control program embodied on a computer readable medium, causing a computer to perform the steps of:
storing skill data indicating, for each of a plurality of processes, at least one operator capable of processing the process;
accepting an input of a job including two or more processes selected from among said plurality of processes;
assigning each of said two or more processes included in said accepted job to at least one operator capable of processing the process with reference to said skill data;
outputting a setting screen for allowing an operator to input a parameter for each of said two or more processes included in said accepted job;
accepting the parameter input by the operator in accordance with said setting screen displayed; and
setting said accepted parameter.

10. The workflow control program according to claim 9, wherein in the case where a parameter which is to be input in a first setting screen corresponding to a first process among said two or more processes has been input in a second setting screen corresponding to a second process among said two or more processes and has already been set in said setting step, said step of outputting a setting screen includes the step of outputting said first setting screen with said already set parameter displayed thereon.

11. The workflow control program according to claim 10, wherein said step of outputting a setting screen further includes the steps of
outputting the setting screen including a modification disabling field for allowing the operator to disable modification of the parameter, and
in the case where said modification disabling field is designated, prohibiting acceptance of a new parameter corresponding to the modification disabling field in said step of accepting the parameter.

12. The workflow control program according to claim 9, wherein
said skill data includes, for each of the operators, a skill level for the process that the operator is capable of processing, and
said assigning step includes the step of assigning each of said two or more processes included in said accepted job preferentially to the operator having a higher skill level.
